(19) United States
(12) Patent Application Publication
(10) Pub. No.: US 2017/0372209 A1
(43) Pub. Date: Dec. 28, 2017

(54) DETERMINATION PROCESS CONTROL METHOD AND DETERMINATION PROCESS CONTROL APPARATUS

(71) Applicant: FUJITSU LIMITED, Kawasaki-shi (JP)

(72) Inventor: Kenji KOBAYASHI, Kawasaki (JP)

(73) Assignee: FUJITSU LIMITED, Kawasaki-shi (JP)

(21) Appl. No.: 15/608,103

(22) Filed: May 30, 2017

(30) Foreign Application Priority Data
Jun. 23, 2016 (JP) 2016-124438

(51) Int. Cl. G06N 5/04; G06N 5/02

(52) U.S. Cl. CPC G06N 5/046; G06N 5/022

(57) ABSTRACT

A determination process control apparatus includes a processor configured to select a first condition on which a determination is to be performed with respect to first data from among a plurality of conditions included in a rule, on basis of first pass efficiency of each of the plurality of conditions. The processor is configured to select a second condition on which a next determination is to be performed with respect to second data from the plurality of conditions on basis of a second pass efficiency of each of the plurality of conditions. The processor is configured to determine, upon determining that the first condition is satisfied, whether the second condition is satisfied with respect to the second data. The processor is configured to output, upon determining that all the plurality of conditions are satisfied, a notification indicating an action to be performed. The action is defined in the rule.

### CROSS-REFERENCE TO RELATED APPLICATION

This application is based upon and claims the benefit of priority of the prior Japanese Patent Application No. 2016-124438, filed on Jun. 23, 2016, the entire contents of which are incorporated herein by reference.

### FIELD

The embodiments discussed herein are related to a determination process control method and a determination process control apparatus.

### BACKGROUND

A technology is known, with which information desired by a user is extracted from big data such as sensor data generated from furniture, home appliances, portable terminals, and smart phones of each home or web data such as a social networking service (SNS), weather, and traffic.

The information desired by the user is defined in a “rule” for each user. A process of distributing the information or controlling the home appliances depending on different tastes or states for each user in accordance with the rule is called “rule processing”. The rule processing is performed by a server. The server determines whether all conditions in a condition set defined by the rule are satisfied, and when all conditions are satisfied, the result of the determination is notified to a home gateway (HGW). Since the HGW is installed in each home to interlock with a device such as the home appliance or furniture in the home, when the condition of the rule processing (e.g., 30° C. or higher on a fine day) is satisfied, it is possible to actuate an air conditioner.

Related technologies are disclosed in, for example, Japanese Laid-Open Patent Publication No. 2010-206569 and Japanese Laid-Open Patent Publication No. 2011-095813.

In the rule processing described above, while any one of conditions is not satisfied, the determination result is not notified to the HGW even though other conditions are satisfied. Therefore, while any one of conditions is not satisfied, determination process of other conditions is performed in vain.

### SUMMARY

According to an aspect of the present invention, provided is a determination process control apparatus including a memory and a processor coupled to the memory. The processor is configured to select a first condition on which a determination is to be performed with respect to first data to be subject to the determination from among a plurality of conditions included in a rule, on basis of first pass efficiency of each of the plurality of conditions. The processor is configured to select a second condition on which a next determination is to be performed with respect to second data to be subject to the next determination from the plurality of conditions on basis of a second pass efficiency of each of the plurality of conditions. The processor is configured to determine whether the first condition is satisfied with respect to the first data. The processor is configured to determine, upon determining that the first condition is satisfied, whether the second condition is satisfied with respect to the second data. The processor is configured to output, upon determining that all the plurality of conditions are satisfied, a notification indicating an action to be performed. The action is defined in the rule.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a rule;

FIG. 2 is a diagram illustrating an example of using rule processing and a determination result according to a first embodiment;

FIG. 3 is a diagram illustrating an example of determination on condition according to a first embodiment;

FIG. 4 is a diagram illustrating an example of a determination process control system according to a first embodiment;

FIG. 5 is a diagram illustrating an example of an all-condition table according to a first embodiment;

FIG. 6 is a diagram illustrating an example of a condition type table according to a first embodiment;

FIG. 7 is a diagram illustrating an example of a data type table according to a first embodiment;

FIG. 8 is a diagram illustrating an example of a condition combination pass efficiency table according to a first embodiment;

FIG. 9 is a diagram illustrating an exemplary hardware configuration of a management server according to a first embodiment;

FIG. 10 is a diagram illustrating transition of a determination state of a condition according to a first embodiment;

FIG. 11 is a flowchart illustrating an exemplary flow of a rule determination order setting process according to a first embodiment;

FIG. 12 is a diagram illustrating rule processing in a rule determination order according to the first embodiment;

FIG. 13 is a flowchart illustrating an exemplary flow of rule processing according to a first embodiment;

FIGS. 14A and 14B are flowcharts illustrating an exemplary flow of rule processing according to a second embodiment;

FIG. 15 is a diagram illustrating rule processing in a rule determination order according to a second embodiment;

FIG. 16 is a diagram illustrating rule processing in a rule determination order according to a second embodiment;

FIG. 17 is a flowchart illustrating an exemplary flow of a rule determination order setting process according to a third embodiment; and

FIG. 18 is a diagram illustrating a determination cost expectation value according to a third embodiment.

### DESCRIPTION OF EMBODIMENTS

Hereinafter, the embodiments will be described with reference to the accompanying drawings. In the description and the drawings, components having a similar functional configuration will be denoted by a similar reference numeral, and redundant descriptions thereof will be omitted.

In recent years, a technology for extracting valuable information by using big data having a large scale has been expected. With the technology, information desired by a user is extracted from the big data and the extracted information is provided to the user. The information desired by the user is defined in a “rule” for each user.

### First Embodiment

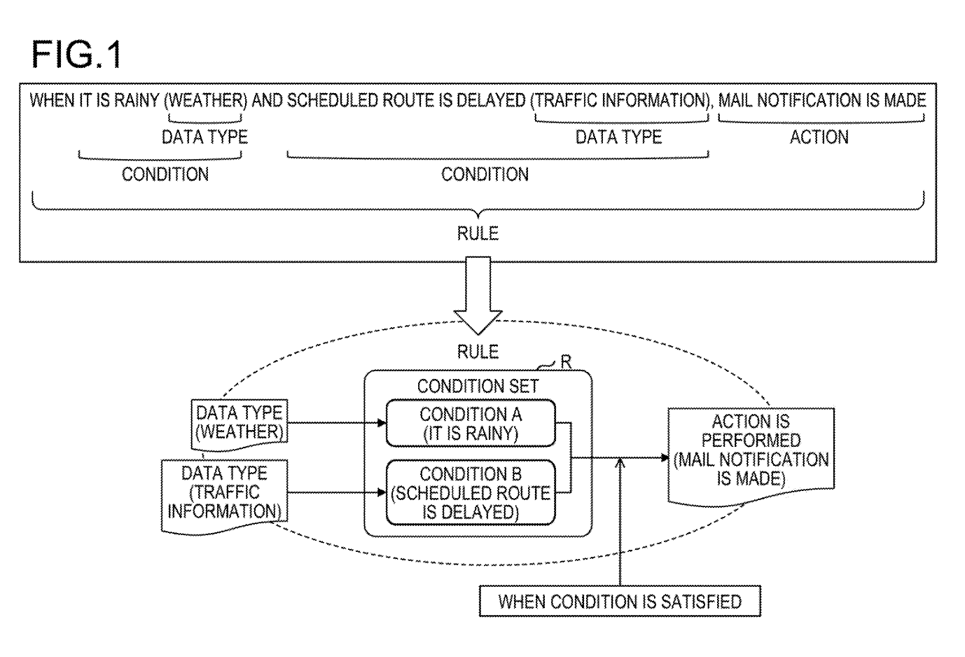

FIG. 1 illustrates an example of a rule. A rule consists of a condition and an action. In the condition, a type (e.g., a room temperature) and a value or a range (e.g., 28° C. or higher) of data to be subject to determination are designated. The action indicates processing to be performed when the condition is satisfied.

For example, in a case where the rule is “when it is rainy (weather) and a scheduled route is delayed (traffic information), a mail notification is made”, the “weather” and the “traffic information” represent types of data. The rule R of FIG. 1 is defined as a condition set including two conditions. In a condition A, a determination value for the data type of the weather is set as “it is rainy”, and in a condition B, the determination value for the data type of the traffic information is set as “a scheduled route is delayed”. As described above, a plurality of conditions may be designated in one rule.

A server determines whether input weather information meets the determination value of the condition A and determines whether input traffic information meets the determination value of the condition B. The server performs the action when both the conditions A and B are satisfied as a result of the determination. In this example, the action is “a mail notification is made”.

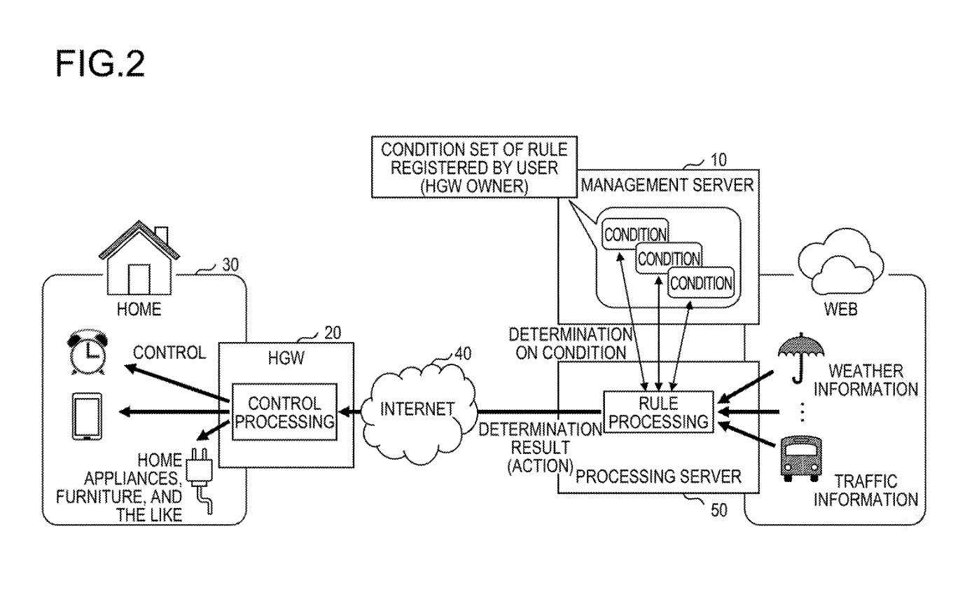

FIG. 2 is a diagram illustrating an example of using rule processing and a determination result according to a first embodiment. A condition set to be subject to rule processing performed by a processing server 50 is conditions of a rule registered by a user as an owner of an HGW 20 and may include a plurality of conditions. The condition set is registered as a rule for each user.

The processing server 50 inputs web data such as weather information or traffic information, and performs “rule processing” of determining whether the input data meets the conditions defined in each rule. The rule is managed by a management server 10.

The processing server 50 performs determination on the plurality of conditions defined in the rule, respectively, and when all conditions are satisfied, the processing server 50 notifies the determination result to the HGW 20. That is, when any one condition is not satisfied, the determination result is not notified to the HGW 20.

The HGW 20 is installed in each home 30. The HGW 20 is coupled with a device such as a home appliance or furniture in the home 30. The HGW 20 is coupled to the management server 10 through a network 40 such as the Internet to relay various data. Since the HGW 20 interlocks with the device such as the home appliance or the furniture in the home, when conditions (e.g., it is sunny (weather) and it is 30° C. or higher (temperature)) is satisfied in the rule processing, it is possible to actuate an air conditioner.

An example of data to be subject to determination in the first embodiment includes data which may be acquired through the network 40, such as data generated from a portable terminal and a smart phone or web data such as a social networking service (SNS), the weather, and traffic. In the first embodiment, data generated from the device such as the home appliance or the furniture in the home 30 is excluded from the data to be subject to determination.

In the rule processing, while any one of conditions is not satisfied, the processing server 50 does not perform the action such as the notification to the HGW even though other conditions are satisfied. That is, while any one of conditions is not satisfied, the result is not changed (the action is not output), regardless of the determination result of other conditions. Therefore, while any one of conditions is not satisfied in the rule processing, the processing server 50 performs the determination process of other conditions in vain.

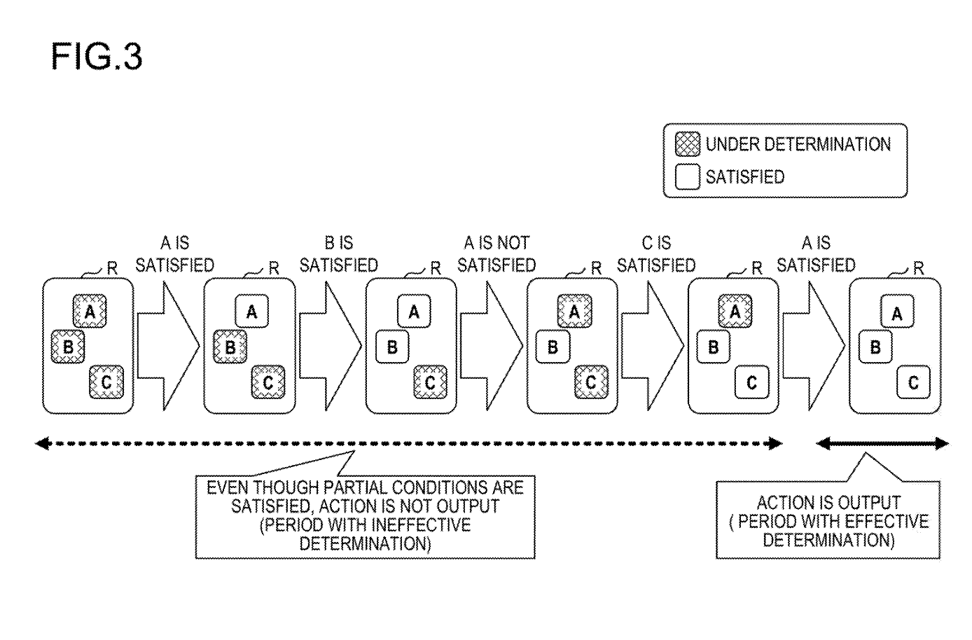

For example, as illustrated in FIG. 3, with respect to a rule R having a condition set including conditions A, B, and C, it is assumed that the processing server 50 performs determination on condition in the order of determination on condition A, determination on condition B, determination on condition A, determination on condition C, and determination on condition A. In this case, while the condition A is not satisfied during the determination, no action is output and the processing server 50 performs determination on other conditions in vain. A timing of outputting the action is a time when the final condition A is determined to be satisfied, and only the determination of that timing is an effective determination.

The processing server 50 inputs a wide variety of data in the rule processing to perform determination on the conditions in the rule defined for each user. Therefore, when the processing server 50 performs whole rule processing, the processing may fail or costs for using the processing server 50 may increase. Accordingly, in first to third embodiments described below, proposed is a determination process control method that performs a control to preferentially perform determination on a condition, which is highly expected not to be satisfied, to reduce a load (processing amount) of the processing server 50.

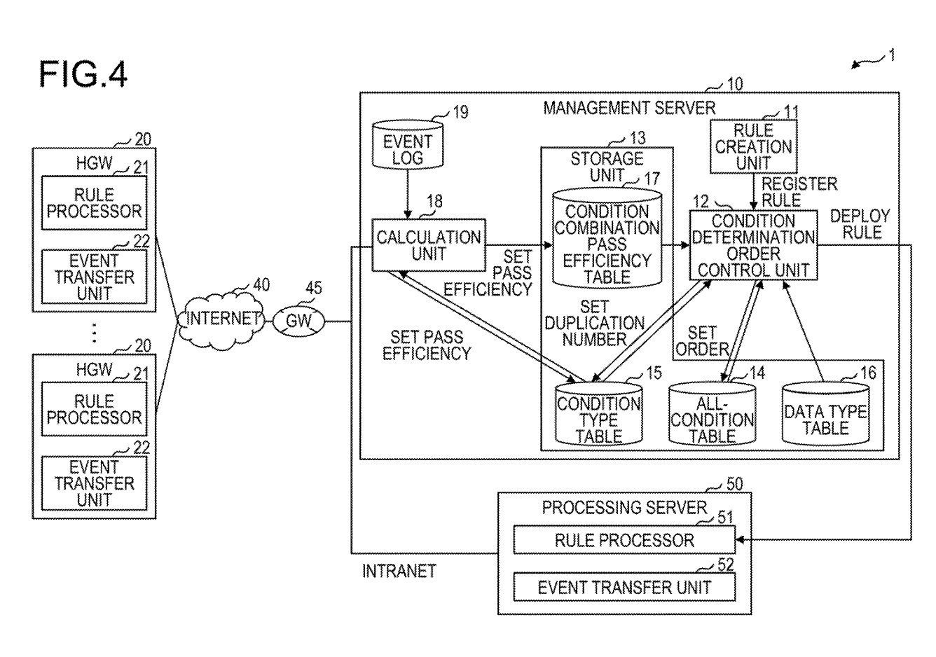

First, a configuration of a determination process control system 1 according to a first embodiment will be described with reference to FIG. 4. FIG. 4 illustrates an example of the determination process control system 1 according to a first embodiment. The determination process control system 1 includes the management server 10, the HGW 20, and the processing server 50. The management server 10 and the processing server 50 are coupled by an intranet. The management server 10 and the processing server 50 are coupled to HGWs 20 through a gateway 45 and a network 40. Herein, two HGWs 20 are illustrated, but the number of HGWs 20 is not limited thereto and may be one or more than two. The HGWs 20 are disposed in the home of each user.

The management server 10 is an example of a determination process control device that performs the determination process control method of preferably performing determination on a condition which is highly expected not to be satisfied. The management server 10 includes a rule creation unit 11, a determination order control unit 12, a storage unit 13, and a calculation unit 18.

The rule creation unit 11 provides an interface (I/F) for creating a rule from a program for each user and transfers the created rule to the determination order control unit 12.

The determination order control unit 12 sets a condition order in the rule on the basis of pass efficiency, a duplication number, a determination cost expectation value, and the like for the rule transferred from the rule creation unit 11, and deploys the set rule so as to be performed by the processing server 50. Upon receiving a notification indicating that a satisfaction state of the condition is changed from the processing server 50, the determination order control unit 12 resets the determination condition order on the basis of the pass efficiency, the duplication number, the determination cost expectation value, and the like, and redeploys the reset rule so as to be performed by the processing server 50.

The storage unit 13 stores therein an all-condition table 14, a condition type table 15, a data type table 16, and a condition combination pass efficiency table 17. Further, the storage unit 13 stores a determination order setting program.

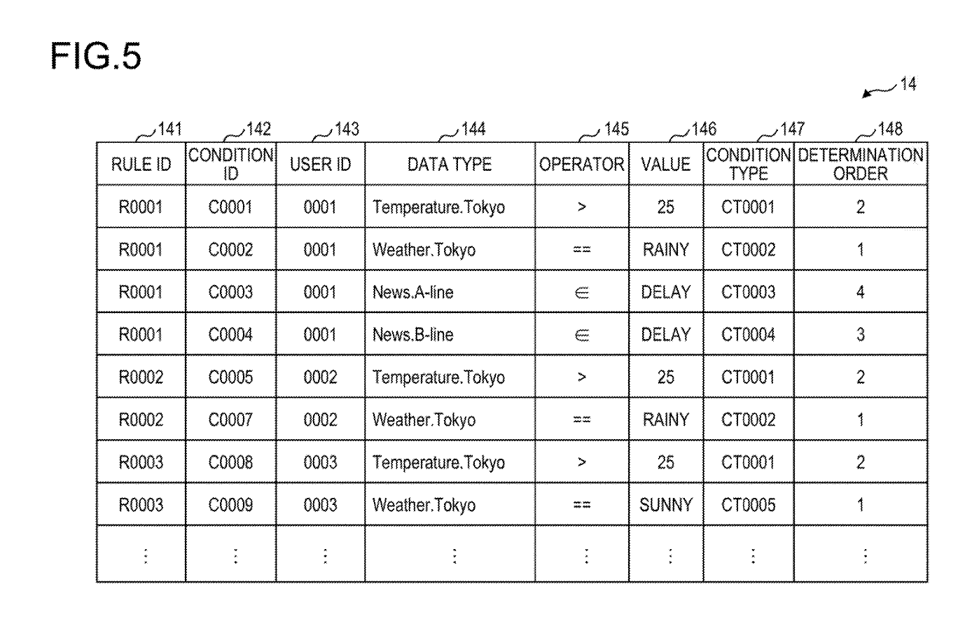

FIG. 5 illustrates an example of the all-condition table 14 according to a first embodiment. The all-condition table 14 stores therein information of a rule identifier (ID) 141, a condition ID 142, a user ID 143, a data type 144, an operator 145, a value 146, a condition type 147, and a determination order 148. In a case of identical conditions, an identical type is set in the condition type 147. The same type or not is determined on the basis of the data type 144, the operator 145, and the value 146. When the data type 144, the operator 145, and the value 146 are respectively identical to each other between conditions, the condition type 147 is also set to be identical to each other. The condition type 147 corresponds to, for example, the name as condition A or B of the rule R of FIG. 1, and in actuality, a value (such as a hash) which is uniquely determined is set to the condition type 147.

In the first embodiment, the determination order 148 is determined based on the pass efficiency calculated by the calculation unit 18. As the pass efficiency, “pass efficiency of each of a plurality of conditions” and “pass efficiency of each of the plurality of conditions in a case of a combination with a condition selected based on the pass efficiency of each of the plurality of conditions” are used.

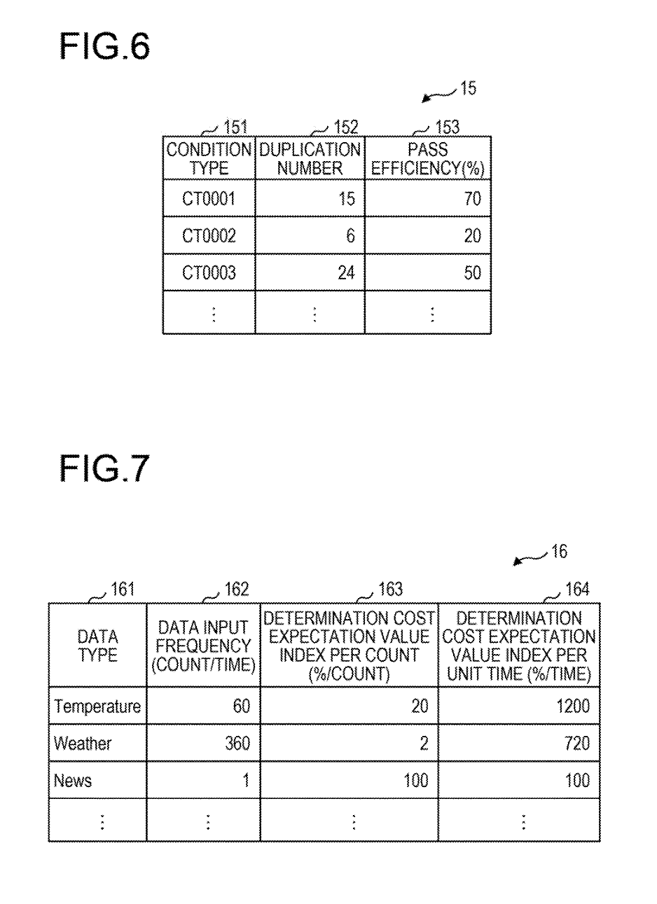

FIG. 6 is a diagram illustrating an example of a condition type table 15 according to the first embodiment. The condition type table 15 stores therein information of a condition type 151, a duplication number 152, and pass efficiency 153. The pass efficiency 153 is an example of “pass efficiency” for “each of the plurality of conditions” represented by the condition type 151. For example, in FIG. 6, the condition type 151 having the lowest pass efficiency among the pass efficiencies of the respective conditions is “CT0002”. Therefore, in FIG. 5, the condition having “CT0002” in the condition type 147 is set at a top determination order (“1” in the determination order 148).

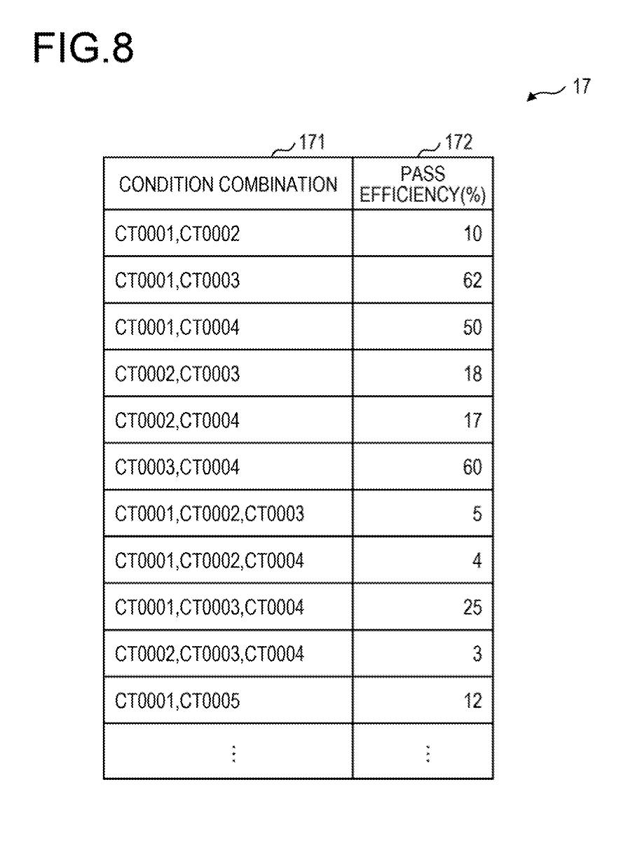

FIG. 7 is a diagram illustrating an example of a data type table 16 according to the first embodiment. The data type table 16 stores therein information of a data type 161, a data input frequency (count/time) 162, a determination cost expectation value index per count (%/count) 163, and a determination cost expectation value index per unit time (%/time) 164. The determination cost expectation value index per unit time 164 is calculated by “the data input frequency 162×the determination cost expectation value index per count 163”.

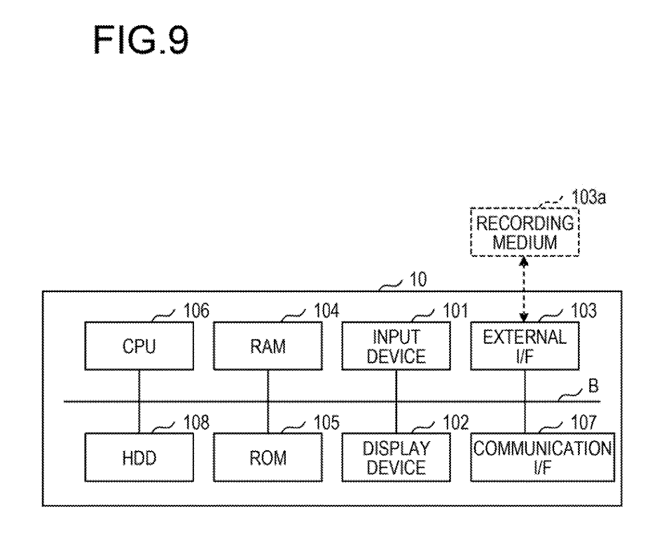

FIG. 8 is a diagram illustrating an example of a condition combination pass efficiency table 17 according to the first embodiment. The condition combination pass efficiency table 17 stores therein information of a condition combination 171 and pass efficiency 172 for the condition combination 171 in association with each other. Even though a value of the pass efficiency 153 for each condition type 151 stored in the condition type table 15 is high, a value of the pass efficiency 172 for the condition combination 171 in which the condition type and another condition type are combined with each other may be low and vice versa. For example, in FIG. 6, the pass efficiency 153 of “CT0001” set in the condition type 151 is high. However, as illustrated in FIG. 8, the value of the pass efficiency 172 is low for the condition combination (CT0001, CT0002) set in the condition combination 171, which includes the condition type “CT0001”.

In the first embodiment, a condition on which determination is performed first for data to be subject to determination is selected from the plurality of conditions on the basis of the pass efficiencies of the plurality of conditions, which are derived from past determination for data. For example, in FIG. 6, the condition which is highly expected not to be satisfied, that is, the condition type 151 “CT0002” having the lowest pass efficiency is selected as a condition at the first determination order, based on the pass efficiency 153 of the respective condition types 151.

Subsequently, on the basis of the pass efficiencies of the respective conditions in a case of being combined with the selected condition, a condition on which determination is performed subsequently for the data to be subject to determination is selected from the plurality of conditions. For example, in FIG. 8, the condition combination 171 combined with “CT0002” having the lowest pass efficiency in FIG. 6 are (CT0001, CT0002), (CT0002, CT0003), and (CT0002, CT0004). Based on the pass efficiencies 172 of the respective condition combinations, the condition which is highly expected not to be satisfied, that is, the condition CT0001 included in the condition combination (CT0001, CT0002) having the lowest pass efficiency is selected as a condition at the second determination order.

Referring back to FIG. 4, in an event log 19, a log of all data serving as input events including the weather, the traffic, and the like is stored. The event log 19 may be maintained in a storage area inside the management server 10 or maintained in a storage area outside the management server 10.

The calculation unit 18 calculates the pass efficiency of each condition on the basis of the event log 19 and the all-condition table 14. The calculation unit 18 also calculates the pass efficiency of each condition combination on the basis of the event log 19 and the all-condition table 14.

Respective conditions defined in a rule have different level of easiness to be satisfied. The calculation unit 18 calculates a “pass efficiency” indicating the easiness to be satisfied for each condition. The pass efficiency may be calculated by “the count of satisfactions ÷ the count of data inputs”. However, the calculation of the pass efficiencies of the respective conditions is not limited to this calculation method. The pass efficiency in this case represents a ratio at which the respective conditions are satisfied for input data (that is, data for which the pass efficiency of the respective conditions is determined). The data, for which the pass efficiency is determined, is stored in the event log 19.

The data type 144, the operator 145, and the value 146 of FIG. 5 represent an example of the condition. For example, when there is a condition that “It is rainy in Tokyo” represented by the data type 144 of “Weather.Tokyo”, the operator 145 of “==”, and the value 146 of “rainy”, and the condition is satisfied only one time among ten times with respect to input weather data, the pass efficiency is 10%. When a condition that “It is sunny in Tokyo” is satisfied 6 times among 10 times, the pass efficiency is 60%. The calculation unit 18 calculates the pass efficiency for each condition to set the calculated pass efficiency in the condition type table 15.

The pass efficiency may be considered also in a combination (hereinafter, also referred to as “combined conditions”) of one condition and another condition and in this case, the pass efficiency indicates a degree of easiness at which the combined conditions are simultaneously satisfied. The calculation unit 18 calculates the pass efficiency for the “combined conditions” to set the calculated pass efficiency in the condition combination pass efficiency table 17.

There are conditions such that even though the pass efficiencies of individual conditions are high, the pass efficiency for a combination of those conditions is low, and vice versa. For example, as in a case of “it is sunny (weather) and it is 20° C. or lower (temperature), in summer”, even any one of “it is sunny” and “it is 20° C. or lower” is well likely to occur, but both conditions are hardly satisfied simultaneously. It may be said that when the former is satisfied, the latter is difficult to be satisfied. A reverse example is a case where both the conditions are easily satisfied simultaneously, like a condition that “it is rainy and a humidity is 60% or higher”.

That is, it may be said that the pass efficiency for the combined conditions is not calculated by multiplication of the pass efficiencies for the individual conditions. This means that the pass efficiency varies depending on a satisfaction state of another condition.

The pass efficiency for combined conditions in which a plurality of conditions are combined with each other represents a ratio at which all conditions included in the combined conditions are satisfied with respect to the input data (that is, data for which the pass efficiency for the combined conditions is determined). The combined conditions are a combination of two or more conditions.

Referring back to FIG. 4, the processing server 50 includes a rule processor 51 and an event transfer unit 52. The rule processor 51 performs determination on each condition for the input event (input data) in accordance with the determination order of the deployed rule on the basis of the deployed rule. When the satisfaction state of a condition is changed, the rule processor 51 notifies the change to the determination order control unit 12. The event transfer unit 52 transfers an event. The processing server 50 stores therein a rule processing program.

The HGW 20 includes a rule processor 21 and an event transfer unit 22. The event transfer unit 22 receives an action from the processing server 50 when conditions (for example, it is sunny (weather) and it is 30° C. or higher (temperature)) are satisfied in the rule processing. The rule processor 21 controls the appliances in the home in response to the reception of the action. For example, the rule processor 21 performs a control such as actuating an air-conditioner disposed in the home.

FIG. 4 is a diagram primarily illustrating functions of the management server 10, the HGWs 20, and the processing server 50, and the respective units illustrated in a functional block may be implemented by only hardware, only software, or a combination of hardware and software.

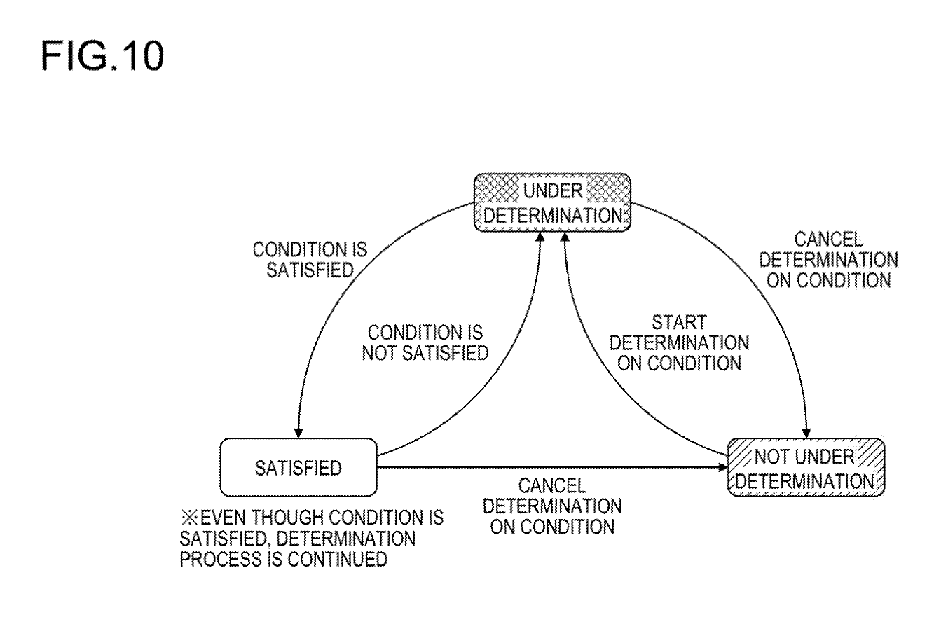

Subsequently, a hardware configuration of the management server 10 will be described with reference to FIG. 9. FIG. 9 illustrates an exemplary hardware configuration of the management server 10 according to the first embodiment. Since the hardware configuration of the processing server 50 according to the first embodiment is similar to the hardware configuration of the management server 10, the description thereof will be omitted herein.

The management server 10 includes an input device 101, a display device 102, an external I/F 103, a random access memory (RAM) 104, a read-only memory (ROM) 105, a central processing unit (CPU) 106, a communication I/F 107, and a hard disk drive (HDD) 108, and the respective devices are coupled to each other through a bus B.

The input device 101 includes, for example, a keyboard or a mouse and is used for inputting each operation signal in the management server 10. The display device 102 includes a display and the like and displays various processing results. The communication I/F 107 is an interface that couples the management server 10 to the network 40. As a result, the management server 10 may perform data communication with the devices such as the processing server 50 and the HGW 20 through the communication I/F 107.

The HDD 108 is a non-volatile storage device storing therein programs and data. The stored programs and data include basic software to control the entire management server 10 and application software. For example, the HDD 108 may store therein various databases, programs and others.

The external I/F 103 is an interface with an external device. The external device includes a recording medium 103a and the like. With this, the management server 10 may perform read and/or write on the recording medium 103a through the external I/F 103. The recording medium 103a includes a compact disk (CD), a digital versatile disk (DVD), a secure digital (SD) memory card, and a universal serial bus (USB) memory.

The ROM 105 is a non-volatile semiconductor memory (storage device) which may keep internal data even though a power supply to the ROM 105 is turned off. The ROM 105 stores therein programs and data such as a network set-up. The RAM 104 is a volatile semiconductor memory (storage device) temporarily keeping programs and data. The CPU 106 is a calculation device that performs processing by reading the programs or data on the RAM 104 from the storage device (e.g., the “HDD 108” or the “ROM 105”) to implement a control of the entire device and installed functions.

With this configuration, in the management server 10 according to the first embodiment, the CPU 106 performs a rule determination order setting process by using a determination order setting program stored in the ROM 105 or the HDD 108. Each of the all-condition table 14, the condition type table 15, the data type table 16, and the condition combination pass efficiency table 17 may be stored in a storage area such as the RAM 104, the HDD 108, or a server on a cloud coupled to the management server 10 through the network 40. In the processing server 50 according to the first embodiment, the CPU performs the rule processing by using a rule processing program stored in the ROM or the HDD.

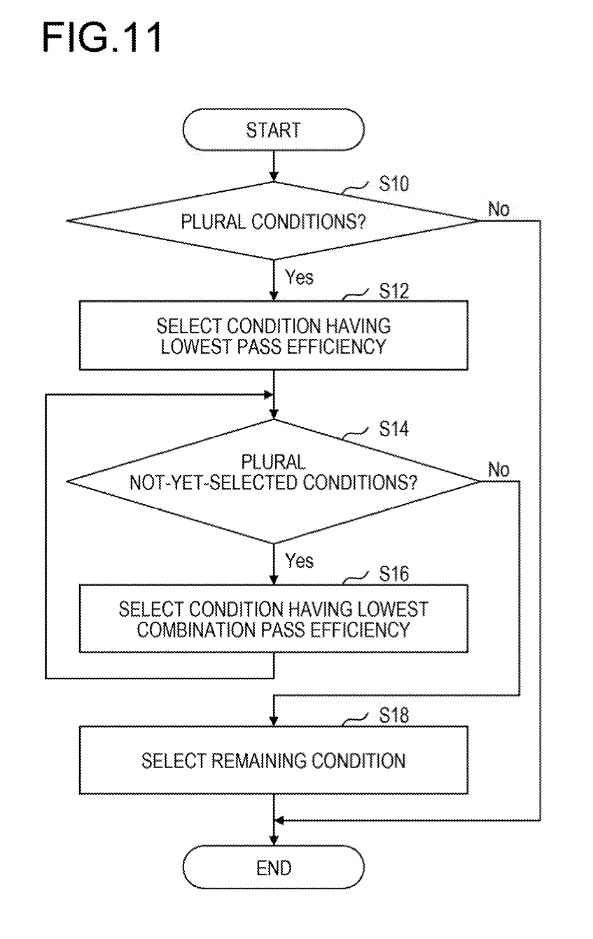

Subsequently, a transition of a determination state of a condition in a rule according to the first embodiment will be described with reference to FIG. 10. FIG. 10 is a diagram illustrating transition of a determination state of a condition according to the first embodiment. The processing server 50 determines whether each condition in the rule is satisfied for input data. At this time, the determination state of the condition is in a state of “under determination”. The determination state of each condition in the rule includes “not under determination”, “under determination”, and “satisfied” as illustrated in FIG. 10 and the states are transitioned to each other.

When the determination on a condition in the state of “not under determination” starts, the determination state of the condition is transitioned from “not under determination” to “under determination”. When it is determined that the condition is satisfied, the determination state of the condition is transitioned from “under determination” to “satisfied”. When the determination on the condition in the state of “under determination” is cancelled, the determination state of the condition is transitioned from “under determination” to the state of “not under determination”.

Even though the determination state of the condition is in the state of “satisfied”, the determination process is continued. When it is determined that the condition is not satisfied, the determination state of the condition is transitioned from “satisfied” to “under determination”. When the determination on the condition in the state of “satisfied” is cancelled, the determination state of the condition is transitioned from “satisfied” to “not under determination”.

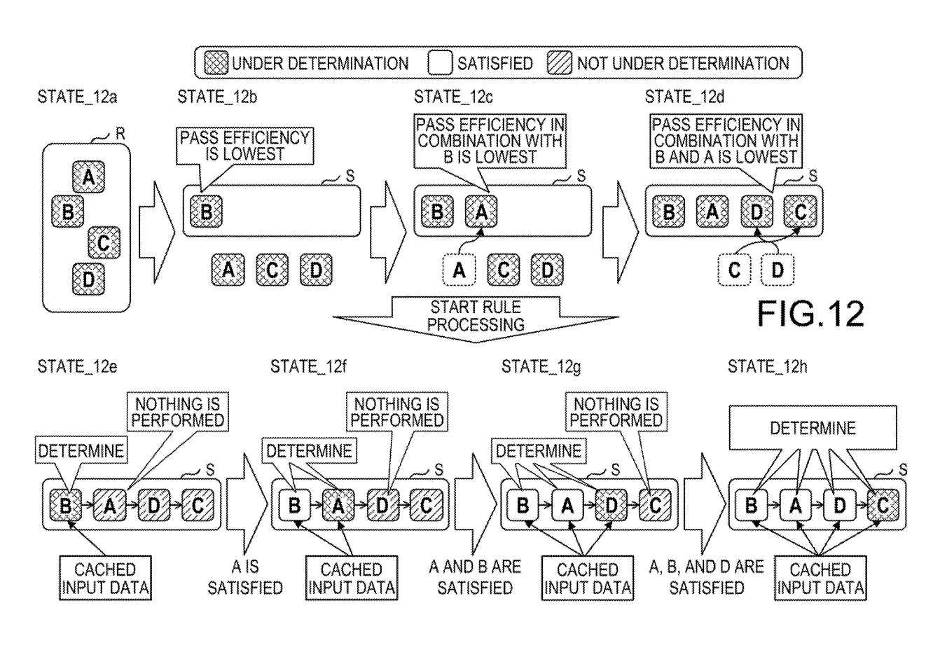

Subsequently, the rule determination order setting process according to the first embodiment will be described with reference to FIG. 11. FIG. 11 is a flowchart illustrating an exemplary flow of the rule determination order setting process according to a first embodiment. The process of FIG. 11 is primarily performed by the determination order control unit 12 of the management server 10.

When the process starts, the determination order control unit 12 determines whether the rule includes a plurality of conditions (S10). Upon determining that the rule includes a plurality of conditions, the determination order control unit 12 selects a condition having the lowest pass efficiency by referring to the condition type table 15 (S12) and disposes the selected condition at the top of the rule. Upon determining that the rule includes a single condition, the determination order control unit 12 immediately ends the process.

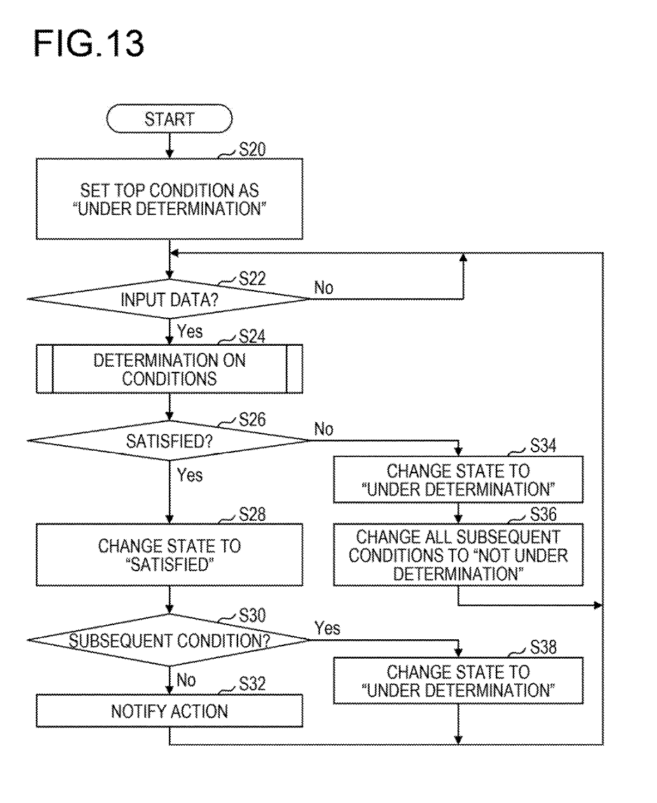

For example, as illustrated in STATE_12a of FIG. 12, the rule R includes conditions A, B, C, and D. Then, as illustrated in STATE_12b of FIG. 12, the condition B having the lowest pass efficiency is selected and disposed in the top of an area S indicating the determination order of the rule.

Referring back to FIG. 11, subsequently, the determination order control unit 12 determines whether there are a plurality of conditions not yet selected (S14). Upon determining that there are a plurality of conditions not yet selected, the determination order control unit 12 selects a condition having the lowest pass efficiency in combination with the already selected conditions (S16) and disposes the selected condition in the area S indicating the determination order of the rule, next to the condition previously disposed. The determination order control unit 12 repeats S14 and S16 while there are a plurality of conditions not yet selected.

For example, when there are the conditions A, C, and D not yet selected as illustrated in STATE_12b of FIG. 12, the condition A having the lowest pass efficiency among the not-yet-selected conditions A, C, and D in combination with the already selected condition B is disposed at the second place of the determination order of the rule as illustrated in STATE_12c of FIG. 12.

Since there are the conditions C and D not yet selected as illustrated in STATE_12c of FIGS. 12, S14 and S16 are repeated again. As a result, the condition D having the lowest pass efficiency among the not-yet-selected conditions C and D in combination with the already selected conditions A and B is disposed at the third place of the determination order of the rule as illustrated in STATE_12d of FIG. 12.

Referring back to FIG. 11, upon determining that there is only one condition not yet selected in S14, the determination order control unit 12 selects the remaining condition and disposes the selected condition at the end of the rule (S18) and ends the process.

For example, when there is only the condition C not yet selected, the condition C is disposed at the end of the rule. In this way, the determination order on the conditions of the rule is determined as illustrated in STATE_12d of FIG. 12. The determination order control unit 12 deploys the rule, in which the determination order on the conditions is determined, in the storage area which may be used by the processing server 50.

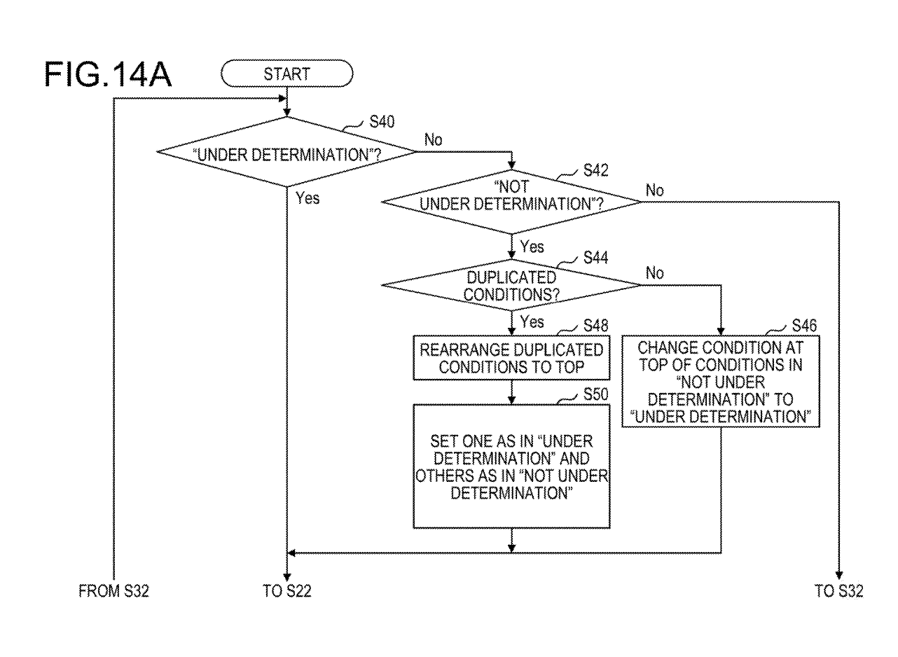

Subsequently, the rule processing according to the first embodiment will be described with reference to FIG. 13. FIG. 13 is a flowchart illustrating an exemplary flow of the rule processing according to the first embodiment. The process of FIG. 13 is primarily performed by the rule processor 51 of the processing server 50.

When the process starts, the rule processor 51 sets only the condition at the top as in the state of “under determination” and sets other conditions in the state of “not under determination” (S20). As a result, for example, as illustrated in STATE_12e of FIG. 12, only the condition B at the top of the deployed rule is set as in the state of “under determination”, and the subsequent conditions A, D, and C are set as in the state of “not under determination”. Therefore, no action is performed on the conditions A, D, and C until the condition B is satisfied. Input data which is received while the determination is stopped with respect to each condition, latest data is cached so that the determination result is not influenced by the ordering.

Subsequently, the rule processor 51 determines whether there is input data with respect to the conditions in the state of “under determination” or the state of “satisfied” (S22). S22 is repeated until input data is received with respect to the conditions in the state of “under determination” or the state of “satisfied”. Upon determining that there is input data with respect to the conditions in the state of “under determination” or the state of “satisfied”, the rule processor 51 performs determination on the conditions (S24).

Subsequently, the rule processor 51 determines whether all the conditions are satisfied (S26). Upon determining that all the conditions are satisfied, the rule processor 51 changes the state of the satisfied conditions to “satisfied” (S28). For example, as illustrated in STATE_12e of FIG. 12, when the input data is cached, determination on the condition B is performed, and when the condition B is satisfied, the state of the condition B is changed to “satisfied” as illustrated in STATE_12f of FIG. 12.

Subsequently, the rule processor 51 determines whether there is a subsequent condition (S30). When the rule processor 51 determines that there is no subsequent condition, the event transfer unit 52 notifies the action to the HGW 20 (S32) and returns to S22. When the rule processor 51 determines that there is a subsequent condition, the rule processor 51 changes the state of the subsequent condition to “under determination” (S38) and returns to S22.

For example, as illustrated in STATE_12f of FIG. 12, the state of the condition A becomes “under determination” in S38. Hereinafter, determination on the conditions A and B are performed. The state of the subsequent conditions D and C remains “not under determination”, and nothing is performed on the subsequent conditions D and C until both the conditions A and B are satisfied.

The repeated process of FIG. 13 is performed and when the conditions B and A of the rule are in the state of “satisfied”, and the condition D is in the state of “under determination” as illustrated in STATE_12g of FIG. 12, determination on the conditions A, B, and D are performed. Nothing is performed on the subsequent condition C until all the conditions A, B, and D are satisfied.

The repeated process of FIG. 13 is further performed and when the conditions B, A, and D of the rule are in the state of “satisfied”, and the condition C is in the state of “under determination” as illustrated in STATE_12h of FIG. 12, determination on the conditions A, B, D, and C are performed.

In this way, when all the conditions of the rule are satisfied, it is determined that there is no subsequent condition in S30. As a result, the event transfer unit 52 notifies the action to the HGW 20 (S32).

When it is determined that any condition is not satisfied in S26, the rule processor 51 changes the state of the condition that is not satisfied to “under determination” (S34). Subsequently, the rule processor 51 changes the state of all the subsequent conditions to “not under determination” (S36) and returns to S22.

As described above, the management server 10 according to the first embodiment determines the order of the determination on the conditions of the rule so as to preferentially perform determination on the conditions with the low pass efficiency. As a result, the processing server 50 according to the first embodiment first performs determination on the conditions with the low pass efficiency in order of the conditions in the deployed rule. Until all the preceding conditions in the rule are satisfied, determination on the subsequent conditions in the rule is not performed.

There are conditions such that even though the pass efficiencies of individual conditions are high, the pass efficiency for a combination of those conditions is low, and vice versa. For example, as in a case of “it is sunny (weather) and it is 20° C. or lower (temperature), in summer”, even though any one of “it is sunny” and “it is 20° C. or lower” is well likely to occur, but both conditions are hardly satisfied simultaneously. A reverse example is a case where both the conditions are easily satisfied simultaneously, like a condition that “it is rainy and a humidity is 60% or higher”.

For example, in the case where the condition set of a certain rule is the conditions A, B, and C, it is assumed that the respective pass efficiencies are the condition A=80%, the condition B=40%, and the condition C=20%. Then, it is further assumed that the pass efficiency for the combination of the condition C and the condition A is 10%, and the pass efficiency for the combination of the condition C and the condition B is 20%. In this case, the processing server 50 first preferentially performs determination on the condition C having the lowest pass efficiency.

In the first embodiment, in the next determination, determination is performed not on the condition B having the second lowest pass efficiency as a single condition but on the condition A having a low probability to occur simultaneously with the condition C (having the low pass efficiency in combination with the condition C).

As a result, the determination process performed by the processing server 50 may be reduced to be performed on the minimum conditions, and a load (processing amount) of the processing server may be reduced. Further, since unnecessary processing is not performed, server costs may be reduced.

The deployment of the rule performed in the rule determination order setting process performed by the determination order control unit 12 and the rule processing performed by the rule processor 51 are separate processes and do not interlock with each other. Therefore, when a new rule is deployed, the determination order of the new deployed rule is used in the next rule processing after the deployment. This is identically applied to other embodiments described below.

### Second Embodiment

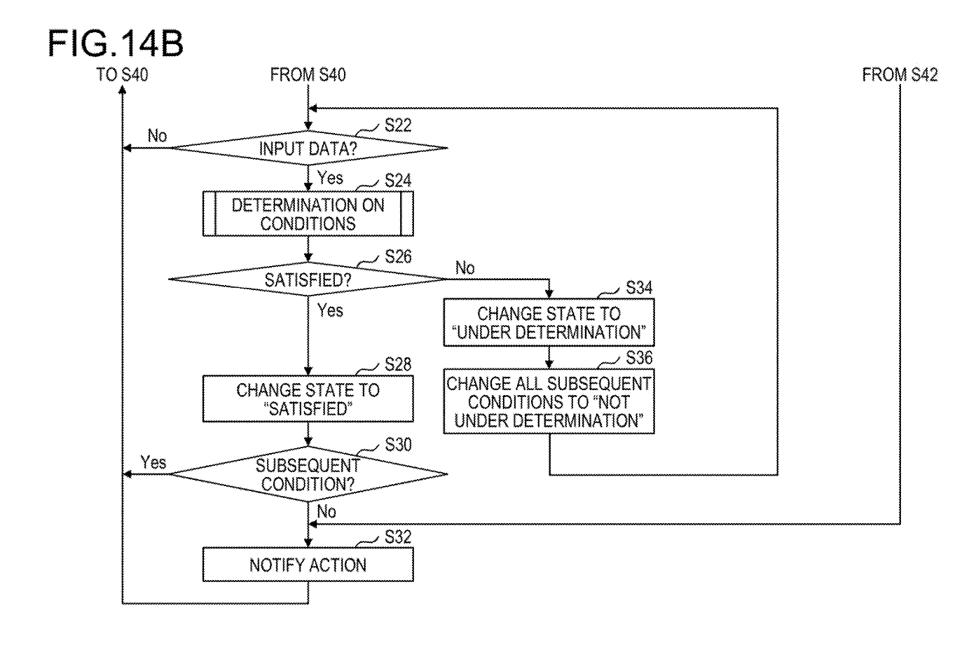

Subsequently, rule processing according to a second embodiment will be described with reference to FIGS. 14A and 14B. FIGS. 14A and 14B are flowcharts illustrating an exemplary flow of the rule processing according to the second embodiment. In the rule processing according to the first embodiment, the state is managed for each condition ID 142 of the all-condition table 14. In this regard, in the rule processing according to the second embodiment, the state is managed for each condition type 147.

When the process starts, the rule processor 51 determines whether there is a condition in the state of “under determination” in the rule (S40). When the rule processor 51 determines that there is a condition in the state of “under determination”, the rule processor 51 proceeds to S22.

Upon determining that there is no condition in the state of “under determination”, the rule processor 51 determines whether there is a condition in the state of “not under determination” (S42). Upon determining that there is no condition in the state of “not under determination”, the rule processor 51 proceeds to S32 to notify of the action, and thereafter, returns to S40.

Upon determining that there is a condition in the state of “not under determination” in S42, the rule processor 51 determines whether there are duplicated conditions (S44). The duplicated conditions are identical conditions included in plural rules in a system. For example, when two users set “when it is sunny in Tokyo” in common, the settings are duplicated conditions. The number of duplication for each identical condition is referred to as a “duplication number”.

Upon determining that there is no duplicated condition among all rules, the rule processor 51 changes a condition positioned at the top of the conditions in the state of “not under determination” to the state of “under determination” (S46) and proceeds to S22.

When the rule processor 51 determines that there are duplicated conditions among plural rules, the duplicated conditions in the respective rules is rearranged to the top (S48). Subsequently, the rule processor 51 sets the duplicated conditions of any one rule to be in the state of “under determination” and sets the duplicated conditions of the remaining rules to be in the state of “not under determination” (S50), and proceeds to S22.

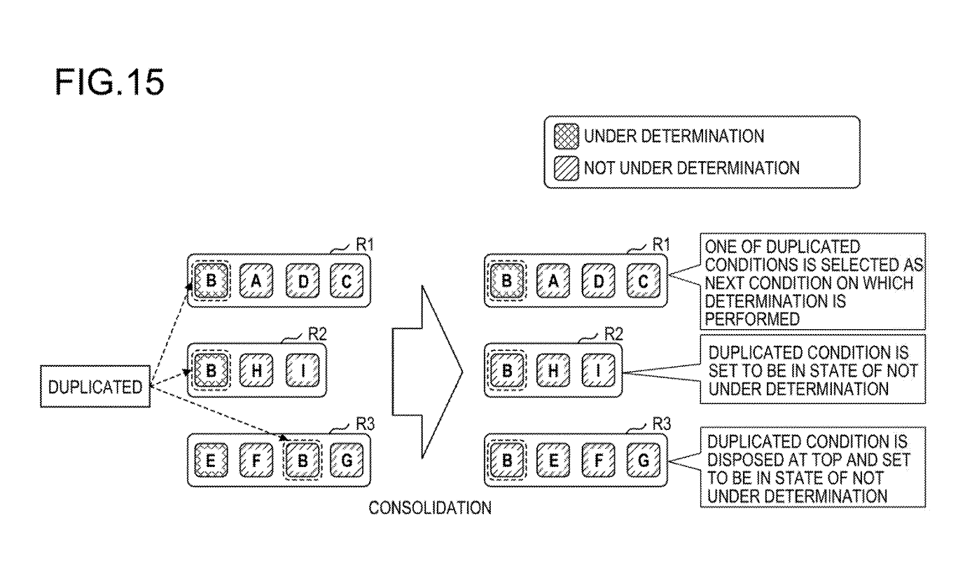

For example, as illustrated in FIG. 15, when rules R1, R2, and R3 include an identical condition in common, the determination order control unit 12 rearranges the order of determination on the identical condition to the top of the conditions in the state of “not under determination” in the respective rules including the identical condition. As a result, the identical conditions are consolidated.

When the rule processor 51 performs determination on the conditions of the respective rules R1, R2, and R3 for each user in order, the rule processor 51 sets the duplicated condition of any one rule to be in the state of “under determination” and sets the duplicated conditions of the remaining rules to be in the state of “not under determination”. In the rule after the consolidation of FIG. 15, the condition B of the rule R1 is in the state of “under determination” and the conditions B of the remaining rules R2 and R3 are in the state of “not under determination”. As a result, by using the determination result on the condition B of the rule R1, determination on the condition B in the rules R2 and R3 are not performed. Thus, the load (processing amount) of the processing server 50 may be reduced.

Referring back to FIGS. 14A and 14B, in S22, the rule processor 51 determines whether there is input data with respect to the conditions in the state of “under determination” or the state of “satisfied”. Upon determining that there is no input data with respect to the conditions in the state of “under determination” or the state of “satisfied”, the rule processor 51 returns to S40. Upon determining that there is input data with respect to the conditions in the state of “under determination” or the state of “satisfied”, the rule processor 51 performs determination on the conditions (S24).

Subsequently, the rule processor 51 determines whether all the condition are satisfied (S26). When the rule processor 51 determines that all the condition are satisfied, the process proceeds to S28 and when the rule processor 51 determines that the any condition is not satisfied, the process proceeds to S34.

In S28, the rule processor 51 changes the state of the satisfied conditions to “satisfied”. Subsequently, the rule processor 51 determines whether there is a subsequent condition (S30) and when the rule processor 51 determines that there is no subsequent condition, the event transfer unit 52 notifies the action to the HGW 20 (S32), and returns to S40. In S30, when the rule processor 51 determines that there is a subsequent condition, the process returns to S40.

When it is determined that any condition is not satisfied in S26 and the process thus proceeds to S34, the rule processor 51 changes the state of the condition that is not satisfied to “under determination”. Subsequently, the rule processor 51 changes the state of all the subsequent conditions to “not under determination” (S36), and the process returns to S22.

In the rule processing according to the second embodiment, in all of the case of “No” in S22 described above, the case of “Yes” in S30, and the case of “notifying the action” in S32, the process returns to S40 to repeat S40 and thereafter.

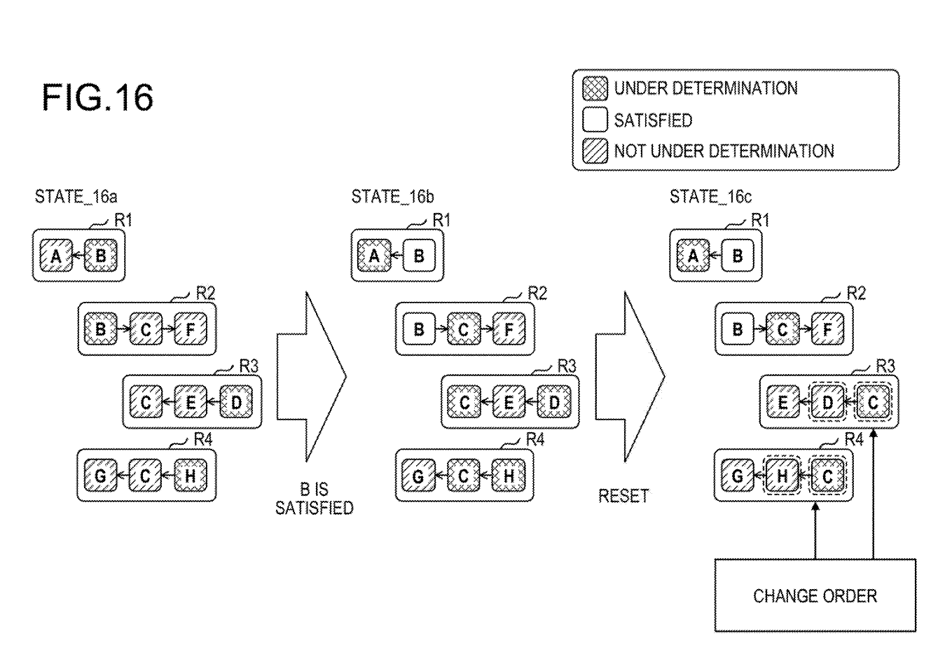

Thus, when the state of each condition is changed, the rule processor 51 may reconfirm the states of all conditions of the rule. For example, it is assumed that the determination order of the conditions in each rule is set as illustrated in rules R1 to R4 of STATE_16a of FIG. 16. When the rule processor 51 determines that the condition B is satisfied, the condition B becomes the state of STATE_16b in FIG. 16.

However, the order of the rules R1 to R4 of STATE_16a of FIG. 16 set first is not necessarily appropriate. Moreover, it is not known which condition is satisfied first, until the rule processing is actually performed. That is, the pass efficiency of a condition becomes higher or lower depending on the satisfaction state for each condition, and the determination order of the respective conditions or the determination order of the duplicated conditions is changed. Therefore, the management server 10 resets the condition order on the basis of the pass efficiency of each condition and the pass efficiency for the combination of conditions in accordance with the change in the satisfaction state of the conditions (e.g., the determination state is changed from the “under determination” to “satisfied”).

The resetting is performed and thus, when the determination order of the conditions is changed in the rules R3 and R4 as illustrated in STATE_16c of FIG. 16, since the conditions C in the rules R2 to R4 are the duplicated conditions, the rule processor 51 consolidates the conditions C and performs the determination on the condition C only once in any one of the rules to reduce the load (processing amount) of the processing server.

As described above, the similar effect to that in the first embodiment may be obtained in the second embodiment. Further, in the second embodiment, the rule processing for the duplicated conditions is consolidated and performed only once in any one rule. As a result, the load (processing amount) of the processing server may be reduced.

In accordance with the change in the satisfaction state of the conditions (e.g., the determination state is changed from the “under determination” to “satisfied”), the determination order of the conditions in each rule is reset based on the pass efficiency of each condition and the pass efficiency for each combination of conditions. As a result, by changing the determination order of the conditions in the rule so as to preferentially determine the condition with the low pass efficiency even when the condition satisfaction state is changed, the determination process may be performed by the processing server 50 on the minimum conditions. As a result, the load (processing amount) of the processing server may be reduced even in any determination state.

### Third Embodiment

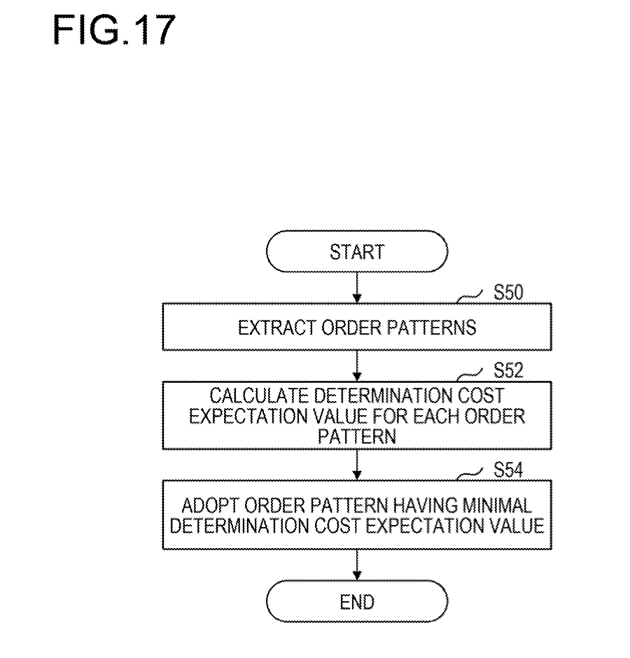

Finally, the rule determination order setting process according to a third embodiment will be described with reference to FIG. 17. FIG. 17 is a flowchart illustrating an exemplary flow of rule determination order setting process according to the third embodiment. In the rule processing according to the third embodiment, the rule processing described in the first embodiment may be performed or the rule processing described in the second embodiment may be performed.

In the rule determination order setting process according to the first embodiment and the second embodiment, the conditions in the rule are sequenced using the “pass efficiency”. In this regard, in the rule determination order setting process according to the third embodiment, the “determination cost expectation value” is calculated using the pass efficiency or the like, and the determination order of the conditions in the rule is determined based on the determination cost expectation value.

For example, it is assumed that the condition A is a light determination that performs only numerical comparison, and the condition B is a heavy determination that extracts a word and compares character strings in a natural language. In this case, although the condition A which is simply a light determination process needs to be first determined, when the pass efficiency of the condition B is lower than that of the condition A, the condition B is first determined, and as a result, the load on the server may become higher than the reverse order.

Therefore, in the rule determination order setting process according to the third embodiment, the determination cost expectation value of each condition is calculated to select a condition having the lowest determination cost. The determination cost expectation value depends on the type of the data used by the condition and further, a value acquired by dividing the determination cost expectation value by the duplication number is adopted. Since an input frequency or processing contents vary for each data, the determination cost expectation value depends on the type of the data used by the condition. As a result, a determination cost expectation value index per time is predetermined. Since the original cost may be reduced as the conditions are further duplicated, the determination cost expectation value index per time is divided by the duplication number.

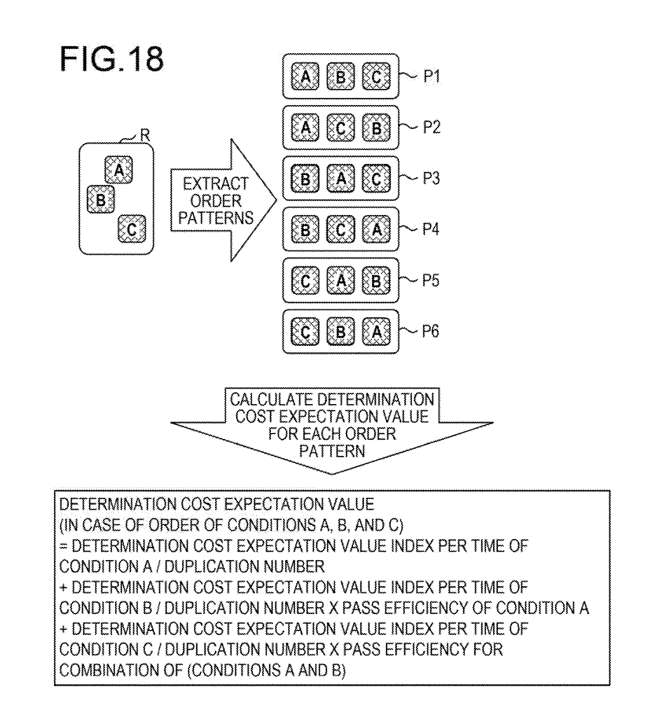

When the rule determination order setting process illustrated in FIG. 17 starts, the calculation unit 18 extracts order patterns of a rule (S50). For example, when there is a rule R having the condition set of conditions A, B, and C of FIG. 18, as the patterns of the condition order, 6 patterns of patterns P1 to P6 are extracted.

Referring back to FIG. 17, subsequently, the calculation unit 18 calculates the determination cost expectation value for each order pattern of the rule (S52). For example, the calculation unit 18 calculates the determination cost expectation value for a pattern P1 (the determination order of condition A→condition B→condition C) of FIG. 18 on the basis of an equation given below. Determination cost expectation value of pattern P1=determination cost expectation value index per time of condition A/duplication number+determination cost expectation value index per time of condition B/duplication number×pass efficiency of condition A+determination cost expectation value index per time of condition C/duplication number×pass efficiency for combination of (conditions A and B)

By using the similar equation, the calculation unit 18 calculates the determination cost expectation value for each of patterns P2 to P6.

Referring back to FIG. 17, subsequently, the determination order control unit 12 adopts the rule with the order pattern in which the determination cost expectation value becomes minimal (S54), and the processing ends. As a result, the rule with the order pattern in which the determination cost expectation value becomes minimal is deployed.

As described above, the management server 10 according to the third embodiment calculates the determination cost expectation value and deploys the rule in which the condition order having the smallest determination cost expectation value is set. As a result, the processing server 50 may first determine the condition having “lower pass efficiency”, a “larger duplication number”, and a “smaller determination cost expectation value”. Therefore, the load (processing amount) of the processing server may be reduced so that the server costs may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
selecting a first condition on which a determination is to be performed with respect to first data to be subject to the determination from among a plurality of conditions included in a rule, on basis of first pass efficiency of each of the plurality of conditions;
selecting a second condition on which a next determination is to be performed with respect to second data to be subject to the next determination from the plurality of conditions on basis of a second pass efficiency of each of the plurality of conditions;
determining whether the first condition is satisfied with respect to the first data;
determining, upon determining that the first condition is satisfied, whether the second condition is satisfied with respect to the second data; and
outputting, upon determining that all the plurality of conditions are satisfied, a notification indicating an action to be performed, the action being defined in the rule.

2. The non-transitory computer-readable recording medium according to claim 1, the process further comprising:
disposing the first condition at a top in the rule;
disposing the second condition next to the first condition in the rule;
repeatedly disposing the plurality of conditions included in the rule to set a determination order of the plurality of conditions such that a next condition is selected from among the plurality of conditions on basis of a third pass efficiency of each of the plurality of conditions in combination with previously selected conditions and the next condition is disposed subsequent to the previously selected conditions;
disposing duplicated conditions included in respective rules at a top of conditions in a first state of not being under determination, the duplicated conditions being an identical condition included in the respective rules; and
selecting one of the duplicated conditions as the first condition.

3. The non-transitory computer-readable recording medium according to claim 2, the process further comprising:
resetting the determination order in response to a change in a determination state of the respective conditions, the determination state including the first state, a second state of being under determination, and a third state of being satisfied.

4. The non-transitory computer-readable recording medium according to claim 3, the process further comprising:
resetting the determination order in response to a change in the determination state from the second state to the third state.

5. The non-transitory computer-readable recording medium according to claim 2, the process further comprising:
calculating a determination cost expectation value on basis of the first pass efficiency, the third pass efficiency, a duplication number indicating a number of conditions having the duplicated conditions, and a predetermined index of a determination cost expectation value per unit time; and
setting the determination order on basis of the calculated determination cost expectation value.

6. The non-transitory computer-readable recording medium according to claim 1, wherein
the first pass efficiency is a ratio of satisfactions of the respective conditions in past determinations, and
the second pass efficiency is a ratio of satisfactions of the respective conditions in combination with the first condition in the past determinations.

7. A determination process control method, comprising:
selecting, by a computer, a first condition on which a determination is to be performed with respect to first data to be subject to the determination from among a plurality of conditions included in a rule, on basis of first pass efficiency of each of the plurality of conditions;
selecting a second condition on which a next determination is to be performed with respect to second data to be subject to the next determination from the plurality of conditions on basis of a second pass efficiency of each of the plurality of conditions;
determining whether the first condition is satisfied with respect to the first data;
determining, upon determining that the first condition is satisfied, whether the second condition is satisfied with respect to the second data; and
outputting, upon determining that all the plurality of conditions are satisfied, a notification indicating an action to be performed, the action being defined in the rule.

8. The determination process control method according to claim 7, further comprising:
disposing the first condition at a top in the rule;
disposing the second condition next to the first condition in the rule;
repeatedly disposing the plurality of conditions included in the rule to set a determination order of the plurality of conditions such that a next condition is selected from among the plurality of conditions on basis of a third pass efficiency of each of the plurality of conditions in combination with previously selected conditions and the next condition is disposed subsequent to the previously selected conditions;
disposing duplicated conditions included in respective rules at a top of conditions in a first state of not being under determination, the duplicated conditions being an identical condition included in the respective rules; and
selecting one of the duplicated conditions as the first condition.

9. The determination process control method according to claim 8, further comprising:
resetting the determination order in response to a change in a determination state of the respective conditions, the determination state including the first state, a second state of being under determination, and a third state of being satisfied.

10. The determination process control method according to claim 9, further comprising:
resetting the determination order in response to a change in the determination state from the second state to the third state.

11. The determination process control method according to claim 8, further comprising:
calculating a determination cost expectation value on basis of the first pass efficiency, the third pass efficiency, a duplication number indicating a number of conditions having the duplicated conditions, and a predetermined index of a determination cost expectation value per unit time; and
setting the determination order on basis of the calculated determination cost expectation value.

12. The determination process control method according to claim 7, wherein
the first pass efficiency is a ratio of satisfactions of the respective conditions in past determinations, and
the second pass efficiency is a ratio of satisfactions of the respective conditions in combination with the first condition in the past determinations.

13. A determination process control apparatus, comprising:
a memory; and
a processor coupled to the memory and the processor configured to:
select a first condition on which a determination is to be performed with respect to first data to be subject to the determination from among a plurality of conditions included in a rule, on basis of first pass efficiency of each of the plurality of conditions;
select a second condition on which a next determination is to be performed with respect to second data to be subject to the next determination from the plurality of conditions on basis of a second pass efficiency of each of the plurality of conditions;
determine whether the first condition is satisfied with respect to the first data;
determine, upon determining that the first condition is satisfied, whether the second condition is satisfied with respect to the second data; and
output, upon determining that all the plurality of conditions are satisfied, a notification indicating an action to be performed, the action being defined in the rule.

14. The determination process control apparatus according to claim 13, wherein
the processor is configured to:
dispose the first condition at a top in the rule;
dispose the second condition next to the first condition in the rule;
repeatedly dispose the plurality of conditions included in the rule to set a determination order of the plurality of conditions such that a next condition is selected from among the plurality of conditions on basis of a third pass efficiency of each of the plurality of conditions in combination with previously selected conditions and the next condition is disposed subsequent to the previously selected conditions;
dispose duplicated conditions included in respective rules at a top of conditions in a first state of not being under determination, the duplicated conditions being an identical condition included in the respective rules; and
select one of the duplicated conditions as the first condition.

15. The determination process control apparatus according to claim 14, wherein
the processor is configured to:
reset the determination order in response to a change in a determination state of the respective conditions, the determination state including the first state, a second state of being under determination, and a third state of being satisfied.

16. The determination process control apparatus according to claim 15, wherein
the processor is configured to:
reset the determination order in response to a change in the determination state from the second state to the third state.

17. The determination process control apparatus according to claim 14, wherein
the processor is configured to:
calculate a determination cost expectation value on basis of the first pass efficiency, the third pass efficiency, a duplication number indicating a number of conditions having the duplicated conditions, and a predetermined index of a determination cost expectation value per unit time; and
set the determination order on basis of the calculated determination cost expectation value.

18. The determination process control apparatus according to claim 13, wherein
the first pass efficiency is a ratio of satisfactions of the respective conditions in past determinations, and
the second pass efficiency is a ratio of satisfactions of the respective conditions in combination with the first condition in the past determinations.
